(19) United States
(12) Patent Application Publication
(10) Pub. No.: US 2014/0189373 A1
(43) Pub. Date: Jul. 3, 2014

(54) METHOD FOR HARD PARTITIONING THE RESOURCES OF A SECURE COMPUTER SYSTEM

(71) Applicants: Benoit Gonzalvo, Roquevaire (FR); Philippe Loubet Moundi, La Ciotat (FR)

(72) Inventors: Benoit Gonzalvo, Roquevaire (FR); Philippe Loubet Moundi, La Ciotat (FR)

(73) Assignee: GEMALTO SA, Meudon (FR)

(21) Appl. No.: 14/239,777

(22) PCT Filed: Jul. 31, 2012
(86) PCT No.: PCT/EP2012/064971

§ 371 Date: Feb. 19, 2014

(30) Foreign Application Priority Data
Aug. 19, 2011 (EP) 11306056.0

(51) Int. Cl. G06F 12/14; G06F 9/50; H04L 9/08

(52) U.S. Cl. CPC G06F 12/1408; H04L 9/0861; G06F 9/5061
USPC 713/193

(57) ABSTRACT

This invention relates to a method for hard partitioning the resources of a secure computer system. The system hardware comprises a hardware mechanism designed to: generate an encryption key with each new program detected by the system, the key being specific to each program, store the said key associated with a program identifier in the system resources, encrypt and store all the data created by the program in the system resources with the key that is specific to it, decrypt the data of the program with the key specific to it in response to a manipulation, call, read and/or write request from a requesting program.

### AREA OF THE INVENTION

This invention relates to a method for hard partitioning the resources of a secure computer system. More particularly, this invention relates to a method for partitioning a non-volatile memory, for example of the flash type. The invention also relates to a system that implements such a partitioning method.

### STATE OF THE ART

In recent years, several software architectures for protecting a memory have been proposed to prevent an attacker from disrupting the working of an application or a program by accessing the said memory in order to retrieve a complete image of it.

One known protection solution consists in managing access to the memory by means of a Memory Management Unit (MMU). According to the MMU principle, each program executed by the operating system is given a protected memory zone, to which no other program has access. As a result, a given program cannot access (for reading and/or writing) the memory used by another program, or even by the operating system itself.

If an attempt to access the off-range memory is detected, the MMU raises an interruption. The interruption is intercepted by the processor, and that generally results in the stopping of the execution of the application, or even a system reset.

However, not all operating systems or virtual machines have an MMU. That is because MMUs are only suited to operating systems or virtual machines where the applications are stored in specific zones of the memory.

The Java Card virtual machine is one example of a virtual machine in which the memory is protected without an MMU. The memory is protected by means of a software mechanism that comprises an isolating mechanism (sometimes called a firewall) that allows the selective passage of information flows between applications. That isolating mechanism is aimed at neutralising unauthorised attempts to access the data of applications from other applications. Such protection provided by the management of access to applications by means of the firewall may be supplemented by protection in the operating system or hardware of the pages of the memory from all unauthorised access attempts.

Such protection of the pages of the memory is obtained by encrypting the content of the memory with a unique encryption key in order to create an environment of execution that can withstand physical attacks and information leaks via the address bus of the processor.

However, such protection of the memory has drawbacks. That is because with physical disruption (injection of faults) of the memory, the attacker can transform the harmless reading of a given application into the retrieval of a complete image of the memory. To reinforce the protection of the memory, another solution is known, consisting in encrypting each page of data in the memory with a key that is specific to it. An attacker who copies the memory can only access applications that share the same page as that via which the copy (or dump) was made. To partition the applications from each other, one page would be required per application, which would deteriorate the optimisation of memory resources.

The major drawback of such memory management lies in the fact that the protection of the memory relies on the software layer regardless of the granularity of protection to be provided for the said memory (encryption of the content of the memory, encryption by page or encryption by application). The drop in the performance of the virtual machine due to the software management of memory protection is particularly sensitive to the granularity of the protection selected. The smaller that granularity, the greater the monopolisation of the system resources that could be used for other purposes.

Thus, the need is currently being felt to improve the protection of the memory while avoiding the deterioration of system performances.

### DESCRIPTION OF THE INVENTION

The invention is precisely aimed at addressing that need. To that end, the invention proposes a method for protecting the memory where management is not handled by the software, but by the hardware.

The invention achieves that by proposing a hardware mechanism capable of firstly managing the identification of programs in order to find the associated keys and secondly protecting the content of the said memory with those same keys.

To that end, the hardware mechanism comprises means designed to generate new keys on request, and store them securely. Each key generated is specific to a program. The mechanism comprises means designed to encrypt the data of the program with the active key generated during a storage phase. The mechanism comprises means capable of decrypting the said data of the program with the said specific key in response to a read, write or call request. The mechanism is capable of encrypting data with granularity of a multiple of a byte

Thus, with the invention, each application can be protected with a dedicated key obtained on request. As a result, a retrieval (or dump) of a complete image of the memory via an application will not allow access to the other applications of the memory. The applications are thus hard partitioned from each other.

This invention thus relates to a method for hard partitioning the resources of a secure computer system. The system hardware comprises a hardware mechanism designed to:
generate an encryption key with each new program detected by the system, the key being specific to each program,
store the said key associated with a program identifier in the system resources,
encrypt and store all the data created by the program in the system resources with the key that is specific to it,
decrypt the data of the program with the key specific to it in response to a manipulation, call, read and/or write request from a requesting program.

The invention also relates to a secure computer system comprising hardware means for executing the method for hard partitioning its resources according to the invention.

In a preferred embodiment, the resources of the system to partition may be of any type of non-volatile memory, existing or future. These memories may be of the flash, MRAM, PCRAM or FeRAM type.

### BRIEF DESCRIPTION OF DRAWINGS

The invention will become easier to understand in the description below and the figures accompanying it. The figures are presented for information and are not limitative in any way.

FIG. 1 shows an illustration of the steps of a mode of operation of the method in the invention.

FIGS. 2 and 3 respectively show a schematic representation of a hardware mechanism that controls access to the resources in one embodiment of the invention.

### DETAILED DESCRIPTION OF THE EMBODIMENTS OF THE INVENTION

This invention will now be described in detail by reference to a few preferred embodiments, as illustrated in the attached drawings. In the description below, numerous specific details are provided in order to allow an in-depth understanding of this invention. However, it will be clear to a person of the art that this invention can be applied without all or part of these specific details.

In order to not make the description of this invention unnecessarily obscure, well-known structures, devices or algorithms have not been described in detail.

It must be remembered that in the description, when an action is allocated to a program or a system comprising a microprocessor, that action is executed by the microprocessor commanded by the instruction codes saved in one memory of that system.

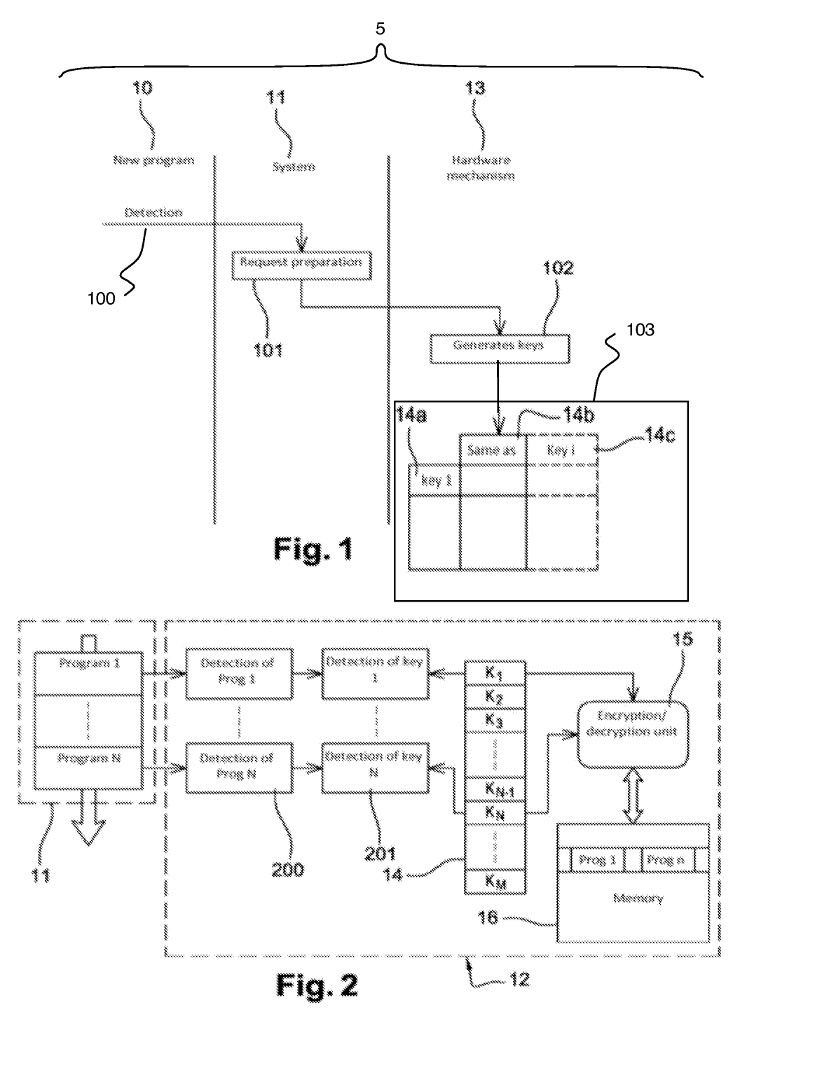

FIG. 1 shows an example of a mode of operation of an initialisation phase of a mode of hard partitioning of the resources of a secure computer system, particularly the programs and data of that system. A secure computer system may be an operating system, an execution environment, a virtual machine etc.

Here, the term hardware is used by opposition with the software layer of the system. In the invention, the partitioning mode is achieved by a hardware mechanism 13 of the hardware 12. That hardware mechanism 13 comprises all the devices incorporated into the hardware 12 designed to execute the partitioning method of the invention.

That hardware mechanism 13 is implemented in the hardware 12 in accordance with constraints relating to the size (capacity) and/or the desired processing speed. In one embodiment, it may be implemented in the memory to partition.

When several programs are executed simultaneously (or alternately) in the system, the execution of one must not affect that of the others or that of the system: they are isolated. Some programs may be allowed to interact with each other, but only as part of a strict data sharing and control policy (firewall). That strict sharing policy and the hardware mechanism in the invention provide protection from the propagation of involuntary programming errors, and also, more importantly, malicious acts (such as dump type attacks) that can affect the proper working of the system and the programs or reveal confidential information.

Program here means not only executable code, that is to say a sequence of instructions, but also the process (or task) that is code that is being executed, with its specific environment made up of data that are specific to it and the resources allocated to it.

Data means not only the values processed by a program, but also the memory zones in which values are stored. Depending on the system, the data belong to the program that has created them, or more generally, to a group of programs with rights to access those data. These rights are managed by the firewall and may be allocated to other programs for particular selected operations: such data are called shareable data.

For example, in the Java Card language (registered trademark of Sun Microsystems), programs are organised in packages, within which the sharing of data (objects and tables) is free. On the other hand, access to data belonging to another package is limited by two software devices: an access management mechanism and a firewall mechanism. That is because in order to access data which do not belong to an element, a request must be made to the virtual machine, which may accept or refuse the request for access. Besides, the firewall filters all the operations that can be carried out on a piece of data, regardless of the means by which it has been obtained. In particular, all read or write operations relating to an object from another package are forbidden, except if a method (program routine) is called that is explicitly declared by the package as being shareable.

Such software protection of access to the data in the memory is supplemented by the memory partitioning method illustrated in FIGS. 1 to 3.

The initialisation phase illustrated in FIG. 1 comprises a preliminary step 100 in which the system 11 detects a new program 10. In step 101, the system 11 prepares a request for the generation of a new key intended for the hardware mechanism 13. The request particularly comprises a program identifier. In one embodiment, the request for the generation of a new key comprises a context materialised by a byte with a numerical program identification value. The context is stored in the headers. In step 102, the hardware mechanism generates a new key Kᵢ specific to the said new program 10. The key may be generated randomly.

At a step 103, the hardware mechanism 12 stores the key Kᵢ in a hardware partitioning memory 14. The memory 14 is for instance structured in a table. For example, one row of the table is a key Kᵢ generated by the hardware mechanism, each table column providing information about the program to which that key is allocated. Thus, the memory 14 particularly comprises a row 14a containing a key Kᵢ, a column 14b which is completed with the identity of the program for which the said key has been generated. All the data created after that by the program 10 are encrypted with the key associated with it.

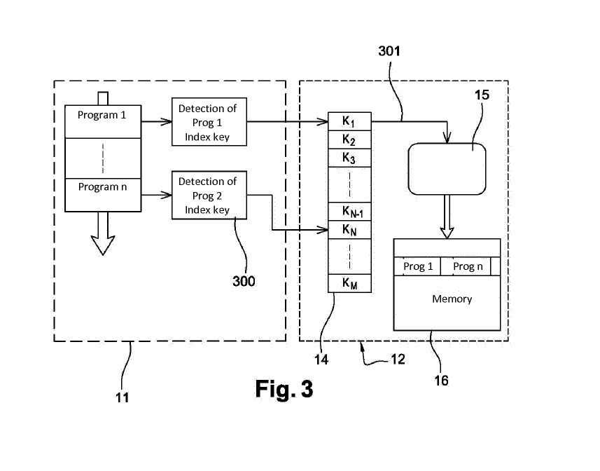

FIG. 2 shows an embodiment where the task of the system 11 is confined to being a relay between the hardware 12 and a program for all manipulation requests (call, read or write) relating to the data of a program.

In the example in FIG. 2, programs 1 to N are executed simultaneously (or alternately) in the system 11. During execution, the programs 1 to N issue requests for manipulating a piece of data. As soon as the system 11 detects such a request for manipulation, the said system sends a message intended for the hardware 12 particularly comprising the manipulation request, and an identifier of the program to which the data to manipulate belong. At one step 200, the hardware mechanism 13 receives the message sent by the system 11. At one step 201, the hardware mechanism 13 extracts the key Kᵢ associated with the identifier of the said program from the memory 14.

If the manipulation request is a write request, the hardware mechanism 13 transmits the extracted key Kᵢ to an encryption/decryption unit 15. The unit 15 is able to encrypt the data of the program received from the system 11 with the key Kᵢ specific to that program. The encrypted data are then stored in the storage memory 16. When the storage memory 16 is organised in pages, several programs can be saved on the same page, while being partitioned from each other.

That granularity of protection allowed by the invention makes it possible, by encrypting the data with a key specific to each program, to create a mechanism for partitioning the data of a program from those of other programs, thus guaranteeing data confidentiality.

If the manipulation request is a request to read or call a piece of data, the hardware mechanism will find the key to use thanks to the identifier of the currently selected program. As soon as the encrypted piece of data is received, the unit 15 decrypts it with the extracted key Kᵢ associated with the program. The hardware mechanism 13 then transmits to the requesting program the decrypted piece of data via the system 11.

If a complete image of the memory is retrieved while executing the manipulation request, the decryption of the data of programs other than the requesting program will use the wrong key.

FIG. 3 shows another embodiment where the role of the system 11 is increased in relation to that described in FIG. 2. In the example in FIG. 3, each time a key Kᵢ is generated by the hardware mechanism during the initialisation phase, an identification reference of that key Kᵢ is transmitted by the hardware 12 to the system 11 to be saved in a database of the system. This identification reference is stored in a column 14c of the row 14a corresponding with the key Kᵢ generated by the partitioning memory 14. This reference is often a pointer or a handle. A pointer is the address at which a piece of data is stored in the memory. A handle is an index in a table of pointers (or more generally in a reference table). The values of pointers and handles also sometimes comprise specific bits that provide information about the piece of data (for example about the referenced memory zone or the information in it) or, in the case of handles, about the associated table.

In another embodiment, the identification reference is generated by the system 11, during the initialisation phase illustrated in FIG. 1, and sent to the hardware 12. To associate the identification reference received with the generated key, the hardware mechanism stores it in the column 14c of the generated key. That identification reference is also stored in the database of the system.

When the system 11 receives a request for manipulating a piece of data from one of the programs 1 to N that is being executed, it extracts, during a step 300, the identification reference of the key Kᵢ associated with the program of the requested data from its database. The system 11 then transmits to the hardware 12 a message that particularly comprises the identification reference extracted and the request for manipulation comprising the identifier of the program to which the data to manipulate belongs.

The hardware mechanism 13 then receives the message sent by the system 11. From the access control memory 14, the hardware mechanism 13 extracts the key Kᵢ associated with the received identification reference.

If the manipulation request is a write request, the hardware mechanism 13 transmits the extracted key Kᵢ to an encryption/decryption unit 15. The unit 15 is able to encrypt the data of the program received from the system 11 with the key Kᵢ specific to that program. The encrypted data are then stored in the storage memory 16.

If the manipulation request is a request to read or call a piece of data, the hardware mechanism 13 will find the key to use thanks to the identification reference received and the identifier of the currently selected program. As soon as the encrypted piece of data is received, the unit 15 decrypts it with the extracted key Kᵢ associated with the program. The hardware mechanism 13 then transmits to the requesting program the encrypted piece of data via the system 11.

The representation of the partitioning 14 and storage memories 16 is only an illustration of the possible layout of components and data storage. In practice, these memories are unified or distributed in accordance with constraints relating to the size (capacity) and/or the desired processing speed.

1. A method for hard partitioning a hardware memory of a secure computer system, controlled by an operating system, by operating a hardware memory partitioning mechanism of a hardware layer of the secure computer system to carry out the following steps:
generating an encryption key with each new program detected by the operating system, the key being specific to each program,
storing the said key associated with a program identifier in the hardware memory,
encrypting and storing in the hardware memory all the data created by the program with the key that is specific to the program,
decrypting the data of the program with the key specific to the program in response to a manipulation, call, read and/or write request from a requesting program.

2. The partitioning method according to claim 1, in which each time a new key is generated by the hardware memory partitioning mechanism, an identification reference of the key is sent to the operating system for storage in a database of the said computer system.

3. The partitioning according to claim 1, in which an identification reference of the generated key is supplied by the operating system to the hardware memory partitioning mechanism for association with the said key in the memory.

4. The partitioning method according to claim 2, in which
the operating system extracts the reference of the key associated with the program of the data required from the database by means of a manipulation request sent by a program,
the operating system then transmits to the hardware memory partitioning mechanism the request for manipulation and the extracted reference,
the hardware memory partitioning mechanism extracts from the hardware memory the key associated with the reference received and encrypts or decrypts the piece of data required depending on the request and the firewall context parameters.

5. The partitioning method according to claim 1, in which the operating system is an execution environment or a virtual machine.

6. The partitioning method according to claim 1, in which the hardware memory of the secure computer system to partition is a non-volatile memory.

7. The partitioning method according to claim 6, in which the non-volatile memory is a flash, MRAM, PCRAM, or FeRAM memory.

8. A secure computer system comprising a hardware memory partitioning mechanism designed to execute instructions carrying out a memory partitioning method, the instructions comprising instructions to cause the hardware memory partitioning mechanism to:
generate an encryption key with each new program detected by the operating system, the key being specific to each program,
store the said key associated with a program identifier in the hardware memory,
encrypt and storing in the hardware memory all the data created by the program with the key that is specific to the program,
decrypt the data of the program with the key specific to the program in response to a manipulation, call, read and/or write request from a requesting program.

9. The partitioning method according to claim 3, in which
the operating system extracts the reference of the key associated with the program of the data required from the database by means of a manipulation request sent by a program,
the operating system then transmits to the hardware memory partitioning mechanism the request for manipulation and the extracted reference,
the hardware memory partitioning mechanism extracts from the hardware memory the key associated with the reference received and encrypts or decrypts the piece of data required depending on the request and the firewall context parameters.

10. The partitioning method according to claim 1, in which the operating system is an execution environment or a virtual machine.

11. The partitioning method according to claim 2, in which the operating system is an execution environment or a virtual machine.

12. The partitioning method according to claim 3, in which the operating system is an execution environment or a virtual machine.

13. The partitioning method according to claim 2, in which the hardware memory of the secure computer system to partition is a non-volatile memory.

14. The partitioning method according to claim 3, in which the hardware memory of the secure computer system to partition is a non-volatile memory.

15. The secure computer system of claim 8 wherein the instructions further comprises instructions to cause the hardware means to:
each time a new key is generated by the hardware memory partitioning mechanism, an identification reference of the key is sent to the operating system for storage in a database of the said secure computer system.

16. The secure computer system of claim 8 wherein an identification reference of the generated key is supplied by the operating system to the hardware memory partitioning mechanism for association with the said key in the hardware memory.

17. The secure computer system of claim 15 wherein the operating system comprises instructions:
to extract the reference of the key associated with the program of the data required from the database by means of a manipulation request sent by a program;
to transmit to the hardware memory partitioning mechanism the request for manipulation and the extracted reference; and
to transmit to the hardware memory partitioning mechanism the request for manipulation and the extracted reference; and
wherein the instructions for the hardware memory partitioning mechanism directs the hardware memory partitioning mechanism to extract from the hardware memory the key associated with the reference received and encrypts or decrypts the piece of data required depending on the request and the firewall context parameters.

18. The secure computer system of claim 8, in which the operating_system is an execution environment or a virtual machine.

19. The secure computer system of claim 8, in which the hardware memory of the secure computer system to partition is a non-volatile memory.

20. The secure computer system of claim 8, in which the non-volatile memory is a flash, MRAM, PCRAM, or FeRAM memory.
